(19) United States
(12) Patent Application Publication
(10) Pub. No.: US 2004/0261303 A1
(43) Pub. Date: Dec. 30, 2004

(54) Display apparatus

(76) Inventors: James White, Newtownabbey (GB); Neil Beattie, Belfast (GB)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/497,278

(22) PCT Filed: Dec. 3, 2002
(86) PCT No.: PCT/EP02/13730

(30) Foreign Application Priority Data
Dec. 3, 2001 (GB) 0128802.6

(51) Int. Cl. G09F 7/00

(52) U.S. Cl. 40/601

(57) ABSTRACT

The invention relates to a display apparatus comprising a base; a display unit rotatable with respect to the base; and drive means arranged to impart rotational movement to the display unit. The display unit is coupled to the base by an actuation mechanism arranged to raise or lower, during use, the display unit with respect to the base. In the preferred embodiment, the display unit comprises a body from which a plurality of radially spaced-apart arms extend, each arm being arranged to carry a respective illuminated display device. The display apparatus is eye-catching and easily maintained.

### FIELD OF THE INVENTION

The present invention relates to display apparatus and particularly, but not exclusively, to display apparatus for carrying advertisements.

### BACKGROUND TO THE INVENTION

Advertisements and the like are commonly displayed using display apparatus such as billboards, wall-mounted panels or suspended banners. Conventionally, such display apparatus are static and the advertisement can only be viewed by an individual who is appropriately positioned with respect to the display apparatus. Moreover, static display apparatus tend not to be eye-catching and are often overlooked by the target audience. This is a particular problem for display apparatus that are suspended from, for example, a ceiling since passers-by tend not to look up as they go about their normal business.

Conventional suspended display apparatus present a further problem in that they are relatively difficult to maintain, particularly in cases where the ceiling is high and scaffolding, or the like, is required to reach the display apparatus.

It would be desirable therefore to provide a display apparatus that is eye-catching, relatively easy to maintain and can be viewed from different positions.

### SUMMARY OF THE INVENTION

Accordingly, the invention provides a display apparatus comprising a base; a display unit rotatable with respect to the base; and drive means arranged to impart rotational movement to the display unit, wherein the display unit is coupled to the base by an actuation mechanism arranged to raise or lower, during use, the display unit with respect to the base.

The rotational movement of the display unit is eye-catching and allows displayed items to be viewed from different positions, while the actuation mechanism allows the display unit to be lowered for convenient maintenance.

Preferably, the actuation mechanism comprises a hoisting assembly including a hoist mechanism and pulley assembly coupled together by a suspension line, the arrangement being such that operation of the hoist mechanism to draw in or feed out a length of suspension line causes the display unit to be raised or lowered respectively with respect to the base.

More preferably, the hoist mechanism is mounted on the base, the pulley assembly is fixed with respect to the display unit, and the suspension line passes around the pulley assembly having one end anchored on the base and the other end engaged by the hoist mechanism.

Preferably, the display unit comprises one or more display devices, the or each display device comprising one or more light sources arranged to illuminate the respective display device. More preferably, the or each display device provides at least one display face, the or each light source being arranged to illuminate an item located on or at the or each display face. Preferably still, the or each display device comprises a light box.

Preferably, the display unit comprises a body from which a plurality of radially spaced-apart arms extend, each arm being arranged to carry a respective display device. Advantageously, the arms are hingedly connected to the body.

Preferably, the display unit is coupled to the actuation mechanism by a drive mechanism, the drive mechanism comprising said drive means and a rotational drive shaft, the drive means being arranged to impart rotational movement to the drive shaft, the display unit being connectable to the drive shaft.

Preferably, the display unit is electrically coupled to the drive mechanism by means of a rotatable electrical connector.

Preferably, the drive shaft is hollow and contains, during use, one or more electrical cables for supplying electricity to the display unit, the rotatable electrical connector being provided at one end of the drive shaft for supplying electricity from the drive mechanism to the or each electrical cable contained within the drive shaft.

Preferably, the pulley assembly is provided on the drive mechanism.

During use, the display unit rotates clockwise or anticlockwise, preferably at one of a number of selectable speeds, about a substantially vertical axis. The display unit can be raised or lowered to any preferred display height and can be lowered to floor level for maintenance activities.

Further advantageous aspects of the invention will become apparent to those ordinarily skilled in the art upon review of the following description of specific embodiments of the invention and with reference to the accompanying drawings.

### BRIEF DESCRIPTION OF THE DRAWINGS

Embodiments of the invention will now be described by way of example and with reference to the accompanying drawings in which:

FIG. 1 is a perspective view of a preferred embodiment of a display apparatus according to the invention;

FIGS. 2a and 2b; illustrate a suspension rig included in the apparatus of FIG. 1;

FIGS. 3a and 3b illustrate a drive mechanism and pulley assembly included in the apparatus of FIG. 1;

FIGS. 4a and 4b illustrate a display unit included in the apparatus of FIG. 1;

FIGS. 5a to 5d illustrate the apparatus of FIG. 1 in various modes of operation; and

FIG. 6 is a perspective view of an alternative display unit for use with the apparatus of FIG. 1.

### DETAILED DESCRIPTION OF THE DRAWINGS

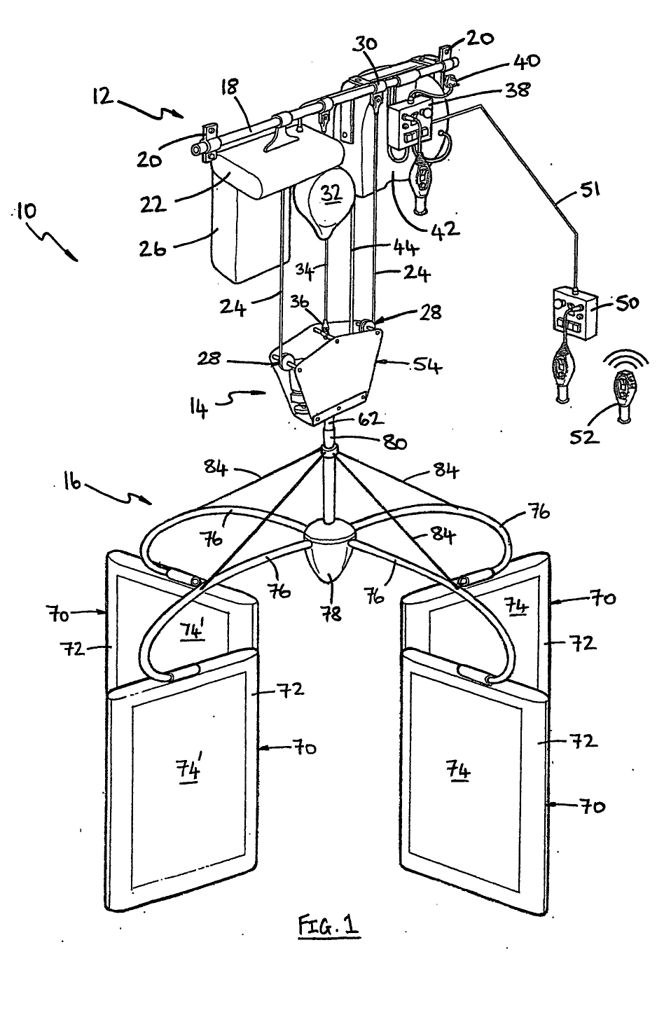

Referring now to FIG. 1 of the drawings there is shown, generally indicated as 10, a preferred embodiment of a display apparatus according to the invention. The apparatus 10 comprises a base preferably in the form of a suspension rig 12, a rotational drive mechanism 14 and a rotatable display unit 16. The apparatus 10 is a suspension-type display apparatus and is mountable, via the suspension rig 12, on a ceiling, wall or other available structure (not shown) such that the display unit 16 is suspended in a desired arena. The apparatus 10 may be used indoors, for example in an airport or mall, or outdoors.

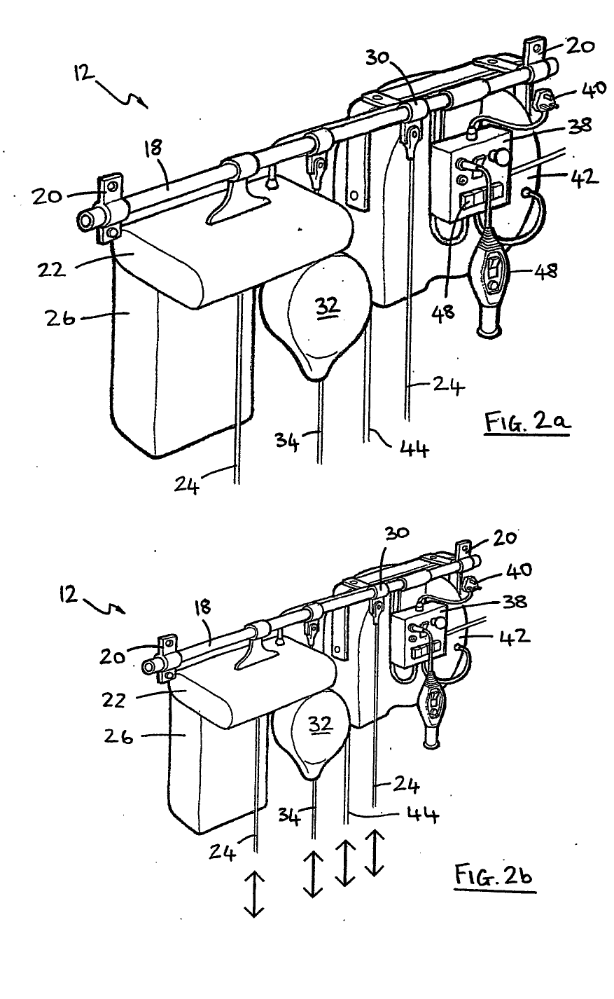

The base or suspension rig 12, which is also illustrated in FIGS. 2a and 2b, serves to provide mechanical and electrical coupling between the apparatus 10 and the structure to which it is mounted during use. The suspension rig 12 comprises a support frame 18 which is mountable on a suitable structure via one or more anchorage points 20. The rig 12 comprises a conventional hoist mechanism 22, or similar lifting mechanism, for drawing in or feeding out a suspension line 24 in the form of, for example, a wire or chain. If required, a receptacle 26 may be associated with the hoist 22 for collecting the retracted portion of the suspension line 24. The suspension line 24 is preferably arranged in a double fall manner by which it passes from the hoist 22, through a pulley assembly 28 provided on the drive mechanism and back to an anchorage point 30 on the support frame 18. Hence, operation of the hoist 22 during use to draw in the line 24 causes the drive mechanism 14, and therefore the display unit 16, to be lifted towards the suspension rig 12, while operation of the drive mechanism 14 during use to feed out the line 24 causes the drive mechanism 14 and display unit 16 to be lowered away from the suspension rig 12. Thus, the hoist 22, suspension line 24 and pulley assembly 28 together provide a preferred actuation mechanism, in the form of a hoisting assembly, for raising and lowering the display unit 16 with respect to the rig 12. In an alternative embodiment, the pulley assembly may be provided on the suspension rig, while the hoist and suspension line anchorage point are provided on the drive mechanism.

The suspension rig 12 preferably also includes a conventional load arrester 32, or similar fall protection device, arranged between the support frame 18 and the drive mechanism 14/display unit 16. The load arrester 32 includes a suspension line 34, typically in the form of a wire cable, one end of which is fixed to the drive mechanism 14 at anchorage point 36. The suspension line 34 is dispensable from the arrester 32 in conventional manner. The load arrester 32 automatically feeds out and draws in the suspension line 34 as the drive mechanism 14/display unit 16 is raised and lowered during use. Should descent of the drive mechanism 14/display unit 16 reach a threshold speed, the load arrester 32 locks thereby preventing further supply of the suspension line 34. The retractable load arrester 32 thus provides a fail-safe brake in the event of hoist 22 slippage or failure.

The suspension rig 12 further includes an electrical control system 38. The control system 38 serves to supply the apparatus 10 with electrical power and, to this end, is depicted in the drawings as having a plug 40 for connection to local electrical mains (not shown). The control system 38 is arranged to supply electricity to the hoist 22 and to the drive mechanism 14/display unit 16 as is described in more detail hereinafter.

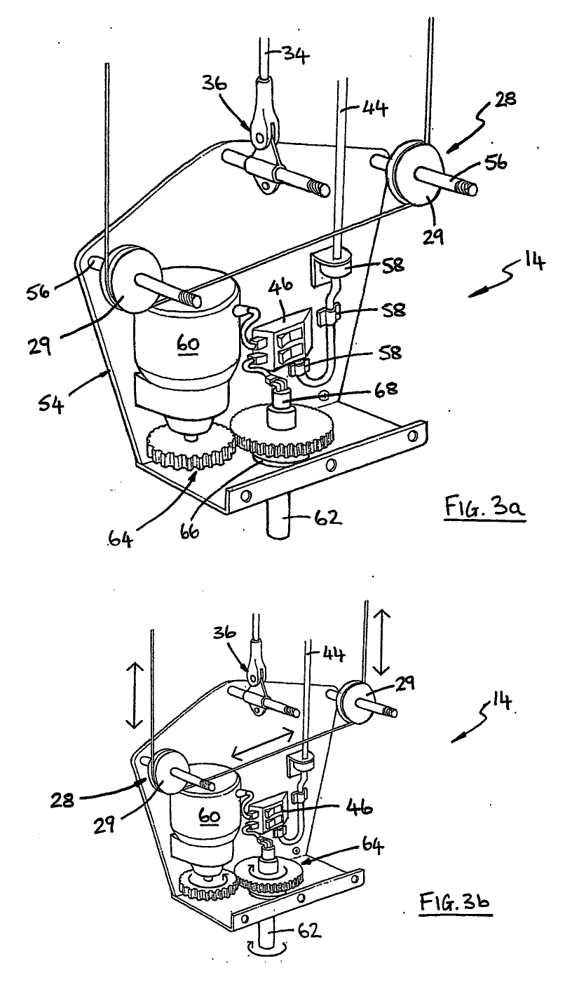

In order to provide an electrical supply to the drive mechanism 14/display unit 16, the suspension rig 12 includes a reel 42 carrying electrical cable 44. The electrical cable 44 is connected to an electrical distribution box 46 (FIG. 3) in the drive mechanism 14 and is retractably wound in the reel 42 by means of any suitable retracting mechanism (not shown). The reel 42 automatically feeds out or draws in the cable 44 as the drive mechanism 14/display unit 16 are raised and lowered during use.

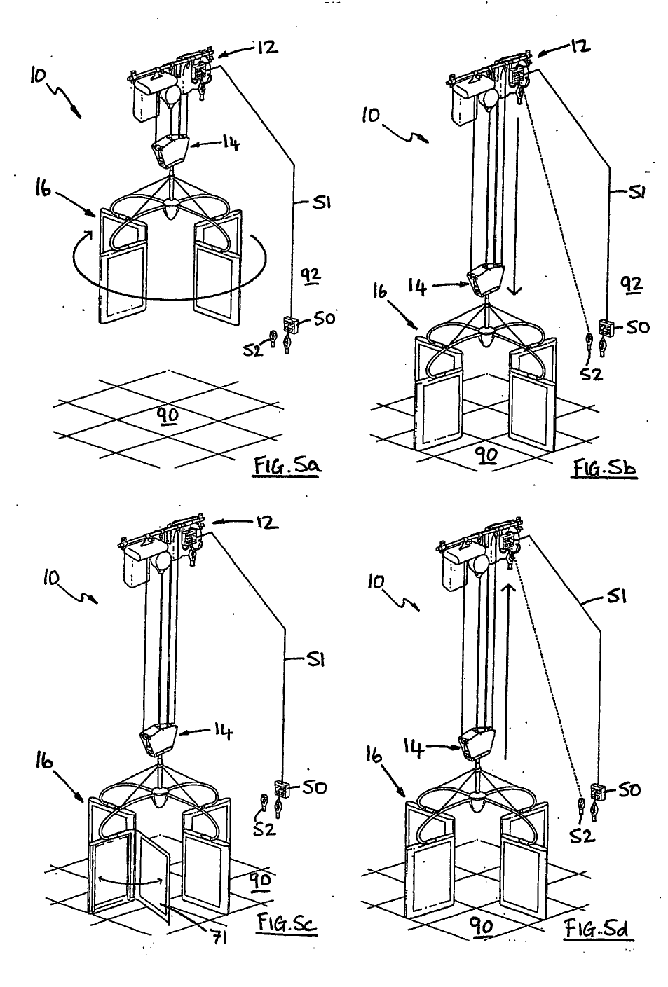

In the preferred embodiment, the control system 38 includes switchgear 48 for operating the apparatus 10 directly from the suspension rig 12. Advantageously, however, the control system 38 is operable remotely via a control panel 50 which is electrically connected, via electrical cable 51, to the control system 38 but remotely located—for example mounted on a convenient wall (See FIG. 5) at a position which may readily be reached by a user (not shown). Alternatively, or additionally, the control system 38 may be arranged to be operable by wireless, e.g. infra-red or radio, remote control via a suitable wireless remote controller 52.

The hoist 22, load arrester 32, reel 42, control system 14 and suspension cables 24, 34 may each be mounted on the support frame 18 by any suitable conventional means. The arrows shown in FIG. 2b indicate the typical movement of the suspension lines and electrical cables 24, 34, 44 during use.

FIGS. 3a and 3b show the drive mechanism 14 with one side of its housing 54 removed to reveal its internal components. The drive mechanism 14 provides electrical power and rotational movement to the display unit 16. The pulley assembly 28 preferably comprises two pulleys 29 rotatable mounted on the housing 54 on respective axles 56. During normal operation, the drive mechanism 14 is coupled to the suspension rig 12 via the pulley assembly 28 and the suspension line 24 as described above. Hence, during normal use, the drive mechanism 14 is suspended below the suspension rig 12. The drive mechanism 14 receives electrical power via cable 44 which feeds the distribution box 46. Conventional mechanical fixings 58 are provided to fix the electrical cable 44 to the housing 54 to prevent any mechanical strain from affecting the connection of the cable 44 to the distribution box 46.

The drive mechanism 14 further comprises drive means in the form of an electric motor 60 arranged to impart rotational movement to a rotatable drive shaft 62 preferably via a gear system 64. Preferably the motor 60 is operable at more than one speed so that, in turn, the drive shaft 62 may be rotated at different speeds. Preferably, a conventional thrust bearing 66 couples the drive shaft 62 to the housing 54 in order to bear the load of the display unit 16 during use. Electrical power is supplied to the drive motor 60 via distribution box 46 in conventional manner.

A rotatable electrical connector 68, for example a commutator or slip ring, is provided for supplying electrical power from the distribution box 46 to the display unit 16. Preferably, the drive shaft 62 is hollow and contains electrical cables (not shown), or other conductors. The rotatable electrical connector 68 is coupled to the rotatable drive shaft 62 and arranged so that electrical power may be supplied from the distribution box 46 to the electrical cables within the shaft 62. Hence, electricity may be supplied to the display unit 16 via the rotatable drive shaft 62 while the display unit 16 is rotating.

The arrows given in FIG. 3b illustrate the typical movement of the suspension cable 24, gear system 64 and drive shaft 62 during use. While FIG. 3a shows the drive shaft 62 rotating in a clockwise direction, it will be understood that the motor 60 and gear system 62 may alternatively be arranged to drive the shaft 62 in an anti-clockwise direction.

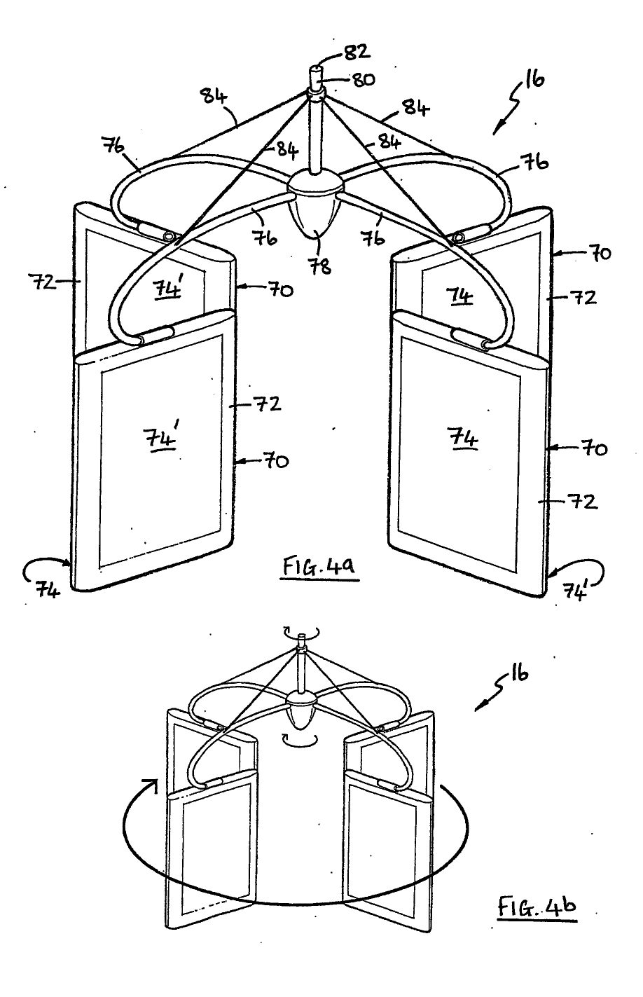

Referring now in particular to FIGS. 1, 4a and 4b, the display unit 16 comprises one or more display devices 70, each of which may carry an advertisement or other item to be displayed. In the preferred embodiment, each display device 70 comprises a respective light box display, or light box. A light box comprises a housing 72 containing one or more electrical light source (not shown) and providing at least one display face 74. In use, a respective advertisement, or other item to be displayed, is placed at or on the or each display face 74 whereupon it is illuminated, or back lit, by the light source. In the preferred embodiment, each light box 70 is generally rectangular in shape and provides two oppositely disposed display faces 74, 74′, one on either side of the light box 70. As may best be seen from FIG. 5c, each light box 70 preferably comprises a respective door 71 associated with each display face 74 to allow an advertisement, or other item, to be placed on or removed from the respective display face 74. A light box 70 is considered to be a particularly effective means for displaying an advertisement, or other item, as the advertisement is illuminated an therefore more eye-catching than a non-illuminated display.

By way of example only, each display face 74 may be approximately 1200mm high and 1800mm wide in which case each light box is particularly suitable for carrying a respective poster of ‘six-sheet’ size on each display face 74.

In the illustrated embodiment, the display unit 16 carries four light boxes 70 although it will be understood that the invention is not limited to such. The display unit 16 may carry one or more display device depending on the application requirements and the size of the respective apparatus 10 components.

Each display device 70 is carried by a respective, preferably hollow, arm 76, the arms 76 radiating from a central point or hub 78. The hub 78 is carried by, or included in, a body in the form of a central shaft 80. Preferably, the central shaft 80 is hollow and comprises an open end 82, distal the hub 78, at which the central shaft 80 is connectable to the drive shaft 62 by any suitable means, e.g. one or more bolts, clamps or other mechanical fixings (not shown). The preferred arrangement is such that the electrical cables contained within the drive shaft 62 pass into and through the hollow central shaft 80 and through the arms 76, via the hub 78, in order to supply electrical power to the respective display devices 70. Where the display device comprises a light box, the electrical supply is normally fed to an electrical ballast (not shown) from which one or more electrical light sources with the light box are supplied. It will be understood that the electrical cables which supply the display unit 16 need not necessarily pass through the drive shaft 62, central shaft 80 and arms 76 but may alternatively be fed along the exterior of one or more of these components. Hence, the drive shaft 62, central shaft 80 and arms 76 need not necessarily be hollow.

In the preferred embodiment, a respective support member 84 in the form of, for example, a rigid strut or flexible line, is arranged between each arm 76 and the central shaft 80 to provide support for the arms 76. Suspending display devices 70 from radially spaced spaced-apart arms 76 is preferred as it optimises the total area of display faces 74 that can be exposed for viewing. As an alternative, the display unit 16 may comprise a multi-sided box or frame (not illustrated) which is connectable to the drive shaft, each side being arranged to carry a respective advertisement or other item to be displayed.

The arrows shown in FIG. 4b illustrate the rotational movement of the display unit 16 during use corresponding to the rotational direction of the drive shaft 62 shown in FIG. 3b.

The typical operation of the apparatus 10 is now described with particular reference to FIGS. 5a to 5d. FIG. 5a shows the apparatus 10 in a normal mode of operation. The suspension rig 12 is fixed to the ceiling (not shown) of a chamber such that the display unit 16 is suspended above the floor 90. The control panel 50 is shown mounted on a wall 92 of the chamber at a height where the control panel 50 is convenient for operation by a user (not shown) standing on the floor 90. The height of the display unit 16 above the floor 90 is adjustable by means of the control system 38 (e.g. via control panel 50) to suit the dimensions and function of the chamber. The display unit 16 rotates about the central shaft 80 (which is substantially vertically disposed during use), as indicated by the arrow, and the light boxes 70 illuminate the advertisements, or other items, located on the respective display faces 74, 74′. In this mode, the display devices 70 are particularly eye-catching for two main reasons: firstly, by virtue of their rotational movement about the central shaft 80; and secondly, by virtue of their illumination. Moreover, since the display devices 70 are rotating, each respective display face 74 may be viewed irrespective of a viewer's location relative to the apparatus 10. Hence, the apparatus 10 is considered to provide a relatively high level of exposure to advertisements, or other items, carried thereby.

FIGS. 5b to 5d illustrate the steps which can be taken when it is desired to perform maintenance operations, such as changing an advertisement, replacing a display device 70, or even maintaining the drive mechanism 14. The first step is normally to disable the rotational and illuminational functions and then to lower the display unit 16/drive mechanism 14 to floor 90 level, or at least to a height above floor level at which the display unit 16/drive mechanism 14 may readily be operated on by a user (FIG. 5b). This may conveniently be achieved using the control panel 50 or remote controller 52, as applicable, to operate the hoist 22 and electrical control system 38. Next, the desired maintenance activities are performed. For example, current advertisements, e.g. posters, may be removed from a light box 70 via the respective door 71 and be replaced by another item (FIG. 5c). Finally, the display device 16/drive mechanism 14 are lifted up (FIG. 5d) to the desired operational height above the floor 90 and the rotational and illuminational functions are re-activated. Thus, maintenance of the apparatus 10 may readily be performed by a user at floor level, without the need for scaffolding or other aids.

The apparatus 10 is not limited to use with display devices in the form of light boxes. Any conventional display device, e.g. a banner, or frame, may alternatively be carried by the arms 76. It is preferred therefore, that the display devices 70 are detachable mounted on the arms 76 so that they can be removed and replaced with a similar or alternative display device.

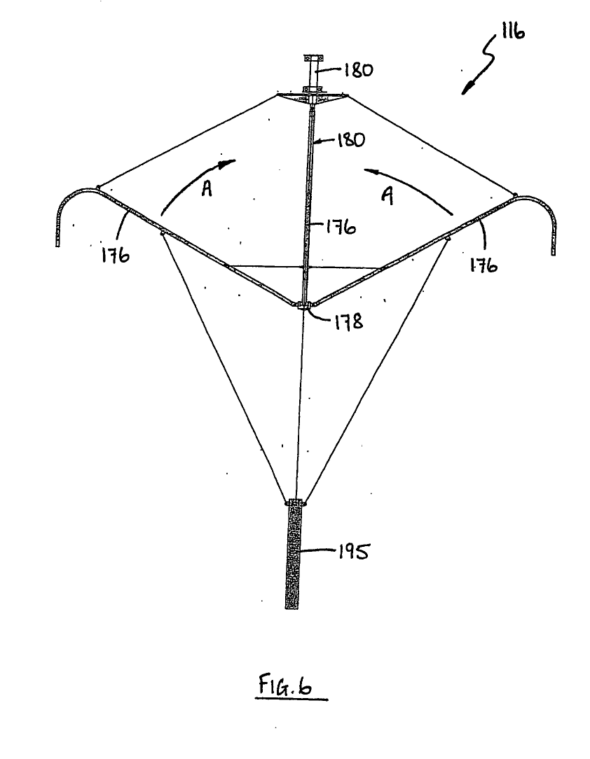

FIG. 6 shows an alternative display unit 116 suitable for use with the apparatus 10 in place of display unit 16. The display unit 116 is generally similar to display unit 16 and comprises a central shaft 180 and a hub 178 from which a plurality of radially spaced arms 176 extend. Display devices are not illustrated in FIG. 6. The arms 176 are pivotably, or hingedly, connected to the central shaft 180 at the hub 178 such that they may be folded in towards the shaft 180 in the direction indicated by arrow A. Hence, the arms 176 are operable between a deployed mode (as illustrated) and a non-deployed mode (not illustrated) in which the arms 176 are folded against, or substantially against, the central shaft 180. With the arms 176 in the non-deployed mode, the display unit 116 is easier to transport or store.

Preferably, the display unit 116 further includes a counter-weight 195 suspended from one or more of the arms 176 to help balance the display unit 116 such that the central shaft 180 remains in a substantially vertical disposition during use.

The invention is not limited to the embodiments described herein which may be modified or varied without departing from the scope of the invention.

1. A display apparatus comprising a base; a display unit rotatable with respect to the base; and drive means arranged to impart rotational movement to the display unit, wherein the display unit is coupled to the base by an actuation mechanism arranged to raise or lower, during use, the display unit with respect to the base.

2. A display apparatus as claimed in claim 1, wherein the actuation mechanism comprises a hoisting assembly including a hoist mechanism and pulley assembly coupled together by a suspension line, the arrangement being such that operation of the hoist mechanism to draw in or feed out a length of suspension line causes the display unit to be raised or lowered respectively with respect to the base.

3. A display apparatus as claimed in claim 2, wherein the hoist mechanism is mounted on the base, the pulley assembly is fixed with respect to the display unit, and the suspension line passes around the pulley assembly having one end anchored on the base and the other end engaged by the hoist mechanism.

4. A display apparatus as claimed in claim 1, wherein the display unit comprises one or more display devices, the or each display device comprising one or more light sources arranged to illuminate the respective display device.

5. A display apparatus as claimed in claim 4, wherein the or each display device provides at least one display face, the or each light source being arranged to illuminate an item located on or at the or each display face.

6. A display apparatus as claimed in claim, wherein the or each display device comprises a light box.

7. A display apparatus as claimed in claim 1, wherein the display unit comprises a body from which a plurality of radially spaced-apart arms extend, each arm being arranged to carry a respective display device.

8. A display apparatus as claimed in claim 7, wherein the arms are hingedly connected to the body.

9. A display apparatus as claimed in claim 1, wherein the display unit is coupled to the actuation mechanism by a drive mechanism, the drive mechanism comprising said drive means and a rotational drive shaft, the drive means being arranged to impart rotational movement to the drive shaft, the display unit being connectable to the drive shaft.

10. A display apparatus as claimed in claim 9, wherein the display unit is electrically coupled to the drive mechanism by means of a rotatable electrical connector.

11. A display apparatus as claimed in claim 10, wherein the drive shaft is hollow and contains, during use, one or more electrical cables for supplying electricity to the display unit, the rotatable electrical connector being provided at one end of the drive shaft for supplying electricity from the drive mechanism to the or each electrical cable contained within the drive shaft.

12. An apparatus as claimed in claim 2, wherein the pulley assembly is provided on the drive mechanism.

13. A display apparatus as claimed in claim 5, wherein the or each display device comprises a light box.
